(19) United States
(12) Patent Application Publication
(10) Pub. No.: US 2024/0021908 A1
(43) Pub. Date: Jan. 18, 2024

(54) BATTERY MODULE AND BATTERY PACK INCLUDING THE SAME

(71) Applicant: LG Energy Solution, Ltd., Seoul (KR)

(72) Inventors: Min Seop Kim, Daejeon (KR); Junyeob Seong, Daejeon (KR); Myungki Park, Daejeon (KR)

(21) Appl. No.: 18/267,086

(22) PCT Filed: Sep. 19, 2022
(86) PCT No.: PCT/KR2022/013943

§ 371 Date: Jun. 13, 2023

(30) Foreign Application Priority Data
Oct. 26, 2021 (KR) 10-2021-0143812

(51) Int. Cl. H01M 10/653; H01M 50/211; H01M 50/291

(52) U.S. Cl. CPC H01M 10/653; H01M 50/211; H01M 50/291

(57) ABSTRACT

A battery module including a battery cell stack having a plurality of battery cells; a housing for the battery cell stack; and an upper thermal conductive material layer located between the upper surface of the battery cell stack and the upper part of the housing. Each of the plurality of battery cells includes a sealing part that seals a part of an outer peripheral surface of the battery cell, and the battery cell is configured such that the sealing part is arranged in a direction extending toward an upper part of the housing. The upper thermal conductive material layer wraps around the outer surface of the sealing part, and a length of the sealing part in a direction extending toward the upper part of the housing is equal to or greater than a length of the sealing part in a direction extending along the upper part of the battery cell.

### CROSS-REFERENCE TO RELATED APPLICATIONS

This application is a US national phase of international application No. PCT/KR2022/013943 filed on Sep. 19, 2022, and claims the benefit of Korean Patent Application No. 10-2021-0143812 filed on Oct. 26, 2021, the entire contents of which are incorporated by reference as if fully set forth herein.

### TECHNICAL FIELD

The present disclosure relates to a battery module and a battery pack including the same, and more particularly to a battery module having enhanced cooling performance and a battery pack including the same.

### BACKGROUND

With the technology development and increased demand for mobile devices, demand for secondary batteries as energy sources has been rapidly increasing. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

In small mobile devices, one to three battery cells are used per device, while medium- or large-sized devices such as vehicles require high power and large capacity. Therefore, a medium- or large-sized battery module having a plurality of battery cells electrically connected to one another is used in such devices.

Since medium- or large-sized battery modules are preferably manufactured with as small a size and weight as possible, a prismatic battery, a pouch-type battery, or the like, which can be stacked with high integration and has a small weight relative to capacity, is mainly used as a battery cell of the medium- or large-sized battery modules. The battery module may include a housing with open front and rear surfaces to house the battery cell stack in the internal space within the housing to protect the battery cell stack from external impact, heat or vibration.

Further, the performance of the secondary battery deteriorate, and in the worst case, there is also a risk of an explosion or ignition when the temperature of the secondary battery rises higher than an appropriate temperature. In particular, for a large number of secondary batteries, that is, a battery module or a battery pack having a plurality of battery cells, the heat generated from the large number of battery cells in a narrow space can add up, so that the temperature can rise more quickly and excessively. That is, a battery module in which a large number of battery cells are stacked, and a battery pack equipped with such a battery module can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

In addition, as the need to include more battery cells in the battery module increases, it is becoming more important to secure stable and effective cooling performance in relation to heat dissipation of the battery module. In addition, recently, as the amount of current per hour is increased to charge the battery module in a relatively short time, the need to solve the heat generation problem of battery cells is increasing.

With the trend of continuing demands such as increased capacity and rapid charging of battery modules, there is a substantial need to develop battery modules that can enhance cooling performance.

### SUMMARY

It is an objective of the present disclosure to provide a battery module having enhanced cooling performance, and a battery pack including the same.

However, the objectives of the present disclosure are not limited to the aforementioned objectives, and other objectives which are not mentioned herein should be clearly understood by those skilled in the art from the following detailed description and the accompanying drawings.

According to one embodiment of the present disclosure, there is provided a battery module comprising: a battery cell stack in which a plurality of battery cells are stacked; a housing that houses the battery cell stack; and an upper thermal conductive material layer located between the upper surface of the battery cell stack and the upper part of the housing, wherein the battery cell includes a sealing part in which a part of an outer peripheral surface of the battery cell is sealed, and the battery cell is configured such that the sealing part is arranged in a direction toward an upper part of the housing, wherein the upper thermal conductive material layer wraps around the outer surface of the sealing part, and wherein the sealing part may have a length extending toward the upper part of the housing that is equal to or greater than a length extending along the upper part of the battery cell.

The sealing part has a length extending toward the upper part of the housing that is greater than a length extending along the upper part of the battery cell.

The sealing part may be folded at least once in a clockwise or counterclockwise direction.

An internal thermal conductive material layer may be located on the folded surface of the sealing part.

The folded surfaces of the sealing part may be in contact with each other.

The housing includes a penetrating part through which a portion of an upper part of the housing penetrates, and the penetrating part may be located on the upper part of the sealing part.

The upper thermal conductive material layer may extend up to the penetrating part.

The length of the penetrating part may be greater than the length of the sealing part in a direction extending along the upper part of the battery cell.

A recessed part is formed on the lower surface of the upper part of the housing, the recessed part is recessed toward the upper surface of the upper part of the housing from the lower surface of the upper part of the housing, and the recessed part may be located on the upper part of the sealing part.

The upper thermal conductive material layer may extend up to the penetrating part and up to the inside of the recessed part.

The size of the recessed part may be larger than the length of the sealing part in a direction extending along the upper part of the battery cell.

The battery module may further comprise a lower thermal conductive material layer located between the lower surface of the battery cell stack and the lower part of the housing.

According to another embodiment of the present disclosure, there is provided a battery pack comprising the above-mentioned battery module.

According to embodiments, the present disclosure provides a battery module and a battery pack including the same in which the sealing part of the battery cell wrapped with the upper thermal conductive material layer is arranged in a direction extending toward the upper part of the housing, and the sealing part has a length extending toward the upper part of the housing that is equal to or smaller than the length extending along the upper part of the battery cell, thereby capable of minimizing thermal resistance of the sealing part and further improving the cooling performance.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a battery module according to one embodiment of the present disclosure;

FIG. 2 is an exploded perspective view of the battery module of FIG. 1;

FIG. 3 is a cross-sectional view along line A-A′ of FIG. 1;

FIG. 4 is an enlarged view of a part of FIG. 3.

FIGS. 5 to 7 are illustrations of a sealing part according to another embodiment of the present disclosure; and

FIGS. 8 and 9 are illustrations of the upper part of the housing according to another embodiment of the present disclosure; and

FIGS. 10 and 11 are illustrations of a sealing part according to a comparative example.

### DETAILED DESCRIPTION

Hereinafter, various embodiments of the present disclosure will be described in detail with reference to the accompanying drawings so that those skilled in the art can easily carry out the described embodiments. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated in the illustrations.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

Hereinafter, a battery module according to one embodiment of the present disclosure will be described. However, the battery module will be described on the basis of the front and rear surfaces thereof, but is not necessarily limited thereto. Even in the case of the rear surface, it may be described in the same or similar manner.

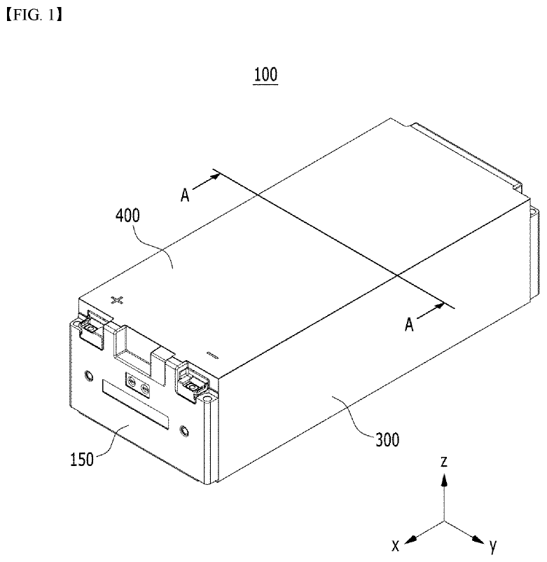

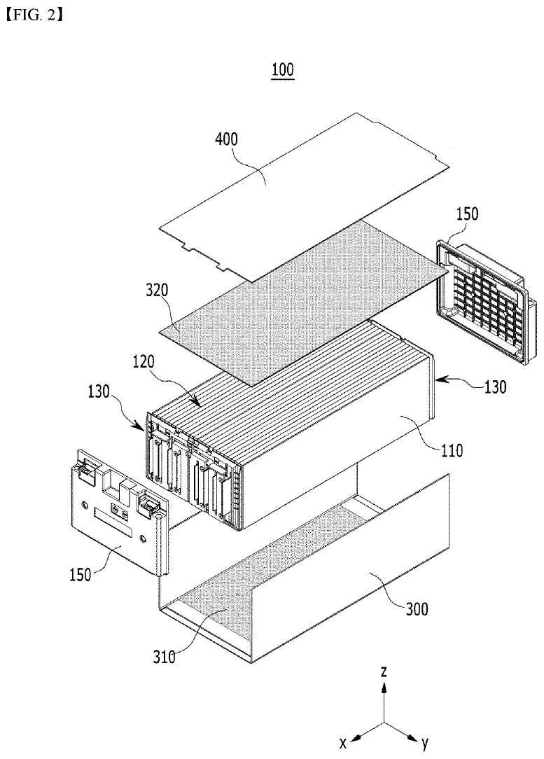

FIG. 1 is a perspective view of a battery module according to one embodiment of the present disclosure. FIG. 2 is an exploded perspective view of the battery module of FIG. 1.

Referring to FIG. 1, a battery module 100 according to the present embodiment includes a battery cell stack 120 in which a plurality of battery cells 110 are stacked, and housings 300 and 400 that house the battery cell stack 120.

Here, the battery cell stack 120 housed in the housings 300 and 400 is configured by stacking a plurality of battery cells 110 in one direction, wherein the battery cell 110 is preferably a pouch-type battery cell. The battery cell 110 can be manufactured by housing the electrode assembly in a pouch case of a laminated sheet including a resin layer and a metal layer, and then heat-sealing a sealing part of the pouch case. A plurality of battery cells 110 may be stacked to be electrically connected to each other, thereby forming a battery cell stack 120.

The housings 300 and 400 include a lower frame 300 that has an open upper surface, front surface and rear surface thereof, and an upper plate 400 that covers the upper surface of the battery cell stack 120. Here, the upper part of the housings 300 and 400 may mean the upper plate 400. In addition, the lower frame 300 includes a bottom part covering the lower surface of the battery cell stack 120 and side surface parts covering the side surfaces of the battery cell stack 120. However, the housings 300 and 400 are not limited thereto, and may be replaced with a mono frame in which one side part is coupled to the upper part of an L-shaped frame, or which surrounds the battery cell stack 120 except for the front and rear surfaces.

Further, referring to FIG. 1, a pair of end plates 150 are located on the front and rear surfaces of the battery cell stack 120, respectively. That is, the pair of end plates 150 may be located on the open front and rear surfaces of the housings 300 and 400.

The housings 300 and 400 and the end plates 150 can be joined by welding or the like in a state in which the mutually corresponding corner portions are in contact. However, this is an exemplary method, and bolt fastening, hook fastening, or the like can be applied as a mechanical coupling form. The battery cell stack 120 is housed in the space formed by the housings 300 and 400 and the end plates 150, thereby being capable of physically protecting the battery cell stack 120. For this purpose, the housings 300 and 400 and the end plates 150 may include a metal material having a predetermined strength such as aluminum or a plastic material.

Meanwhile, the battery module 100 according to the present embodiment includes a pair of busbar frames 130 located between the battery cell stack 120 and the respective end plate 150. More specifically, the busbar frames 130 includes a first busbar frame and a second busbar frame, wherein the first busbar frame is located on the front surface of the battery cell stack 120, and the second busbar frame is located on the rear surface of the battery cell stack 120.

Further, the battery module 100 may include an insulating cover (not shown) located between the busbar frame 130 and the respective end plate 150. That is, the busbar frames 130, the insulating covers (not shown), and the end plates 150 may be located in this order outwards from each of the front and rear surfaces of the battery cell stack 120.

Further, a lower thermal conductive material layer 310 may be located between the battery cell stack 120 and the lower frame 300. In one example, the lower thermal conductive material layer 310 may be formed by applying a thermal conductive resin onto the lower frame 300 and then curing it, before the battery cell stack 120 is mounted on the lower frame 300. In another example, the lower thermal conductive material layer 310 may be made of a material such as a thermal conductive film or a thermal conductive pad in addition to the thermal conductive resin. However, the present disclosure is not limited thereto, and any material including a thermal conductive material can be included in this embodiment.

Thereby, the lower thermal conductive material layer 310 can transfer heat generated in the battery cell 110 to the bottom of the battery module 100 to cool the battery cell 110.

The sealing part 110s of the battery cell 110 and the upper thermal conductive material layer 320 will be described in detail below on the basis of the upper part of the housings 300 and 400.

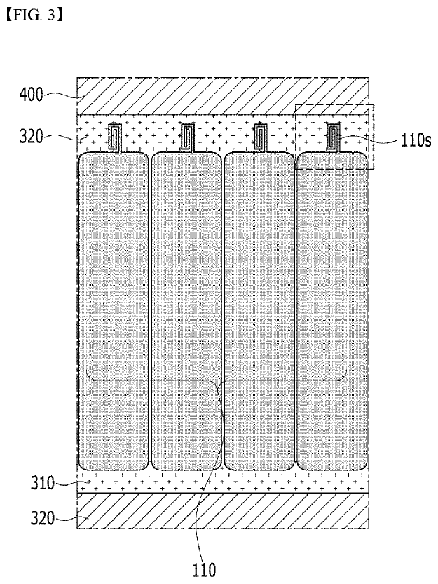

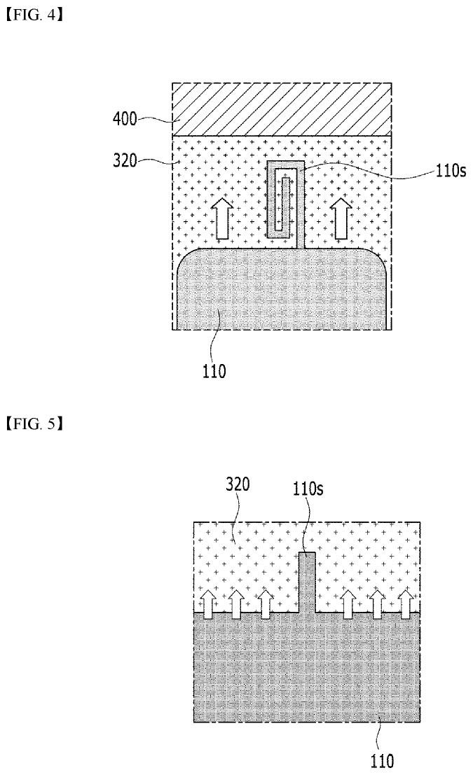

FIG. 3 is a cross-sectional view along line A-A′ of FIG. 1. FIG. 4 is an enlarged view of a part of FIG. 3.

Referring to FIGS. 3 and 4, the battery cell 110 of the battery module 100 of the present embodiment includes a sealing part 110s which seals a part of the outer peripheral surface of the battery cell 110. In one example, the sealing part 110s can be formed by press-sealing or heat-sealing a part of the outer peripheral surface of the battery cell 110.

Here, the battery cell 110 may be arranged in a direction in which the sealing part 110s extends toward the upper parts of the housings 300 and 400 as shown in FIG. 3. In one example, the battery cell 110 may be arranged such that the sealing part 110s extends toward the upper plate 400.

Thereby, the lower part of the battery cell 110 is not formed with the sealing part 110s, so that heat transfer between the battery cell 110 and the lower thermal conductive material layer 310 can be performed relatively easily, and the cooling performance can be further improved.

Referring to FIGS. 2 to 4, the battery module 100 according to the present embodiment includes an upper thermal conductive material layer 320 located between the upper surface of the battery cell stack 120 and the upper part of the housings 300 and 400. Here, the upper thermal conductive material layer 320 may cover the outer surface of the sealing part 110s. More specifically, the upper thermal conductive material layer 320 may come into contact with the outer surface of the sealing part 110s.

In one example, after the battery cell stack 120 is mounted on the lower frame 300, the upper thermal conductive material layer 320 can be formed by applying the thermal conductive resin onto the battery cell stack 120 and then curing it. In another embodiment, the upper thermal conductive material layer 320 may be made of a material such as a thermal conductive film or a thermal conductive pad, in addition to the thermal conductive resin. However, the present disclosure is not limited thereto, and any material including a thermal conductive material can be included in the present embodiment.

Thereby, the upper thermal conductive material layer 320 can transfer heat generated in the battery cell 110 to the upper part of the battery module 100 to cool the battery cell 110.

Further, referring to FIGS. 3 and 4, the length of the sealing part 110s in a direction extending toward the upper part of the housings 300 and 400 is equal to or greater than the length of the sealing part 110s in a direction extending along the upper part of the battery cell 110. In one embodiment, as shown in FIGS. 3 and 4, the length of the sealing part 110s in a direction extending toward the upper part of the housings 300 and 400 is greater than the length of the sealing parts 110s in a direction extending along the upper part of the battery cell 110.

Thus, in the present embodiment, the area occupied by the sealing part 110s can be minimized in the heat transfer path from the upper part of the battery cell 110 toward the upper thermal conductive material layer 320. That is, a heat transfer area between the battery cell 110 and the upper thermal conductive material layer 320 can be maximized by maximizing the contact area between the upper part of the battery cell 110 and the upper thermal conductive material layer 320, and the cooling performance of the battery cell 110 by the upper thermal conductive material layer 320 can be improved.

The sealing part 110s may be folded at least once in a clockwise or counterclockwise direction. In one example, as shown in FIGS. 3 and 4, the sealing part 110s may be folded twice in a counterclockwise direction.

Here, the length by which the sealing part 110s extends along the upper part of the battery cell 110 may mean the portion extending along the upper part of the battery cell 110 on the basis of the entirety of the sealing part 110s that is folded at least once. Also, the length by which the sealing part 110s extends toward the upper part of the housings 300 and 400 may mean a portion extending toward the upper part of the housings 300 and 400 on the basis of the entirety of the sealing part 110s that is folded at least once.

Further, the folded surfaces of the sealing part 110s may be in contact with each other. In other words, as the sealing part 110s is folded at least once, the folded surfaces may be in contact with each other.

Thus, in the present embodiment, when the area of the sealing part 110s is relatively large, the sealing part 110s is folded at least once while improving the sealing performance of the battery cell 110 to maximize space utilization within the battery module 100. Moreover, the area occupied by the sealing part 110s on the upper part of the battery cell 110 can be minimized even when the sealing part 110s is folded at least once.

In one example, a part of the upper thermal conductive material layer 320 may be located between the folded surfaces of the sealing part 110s. When the upper thermal conductive material layer 320 is formed by applying a thermal conductive material onto the upper part of the battery cell stack 120, a part of the thermal conductive material can inflow between the folded surfaces of the sealing parts 110s.

In another example, an internal thermal conductive material layer may be located on the folded surface of the sealing part 110s. Here, the thermal conductive material constituting the inner thermal conductive material layer may have a thermal conductivity higher than or equal to that of the thermal conductive material constituting the upper thermal conductive material layer 320.

More specifically, the upper thermal conductive material layer 320 and the inner thermal conductive material layer may each include at least one of acrylic and silicon materials. However, the present disclosure is not limited thereto, and generally, any material having thermal conductivity can be included in the present embodiment.

Thereby, in the battery cell 100 of the present embodiment, a thermal conductive material is included in the inside of the sealing part 110s, so that the degree of heat transfer between the sealing part 110s and the upper thermal conductive material layer 320 can be enhanced, and the cooling performance of the upper thermal conductive material layer 320 for the battery cells 110 can be improved.

Further, in the battery cell 100 according to another embodiment of the present invention, a fixing member (not shown) can be attached to the outer surface of the sealing part 110s. In one example, the fixing member (not shown) can be made of a material such as a tape or a general adhesive material. In another example, the fixing member (not shown) may be made of an adhesive material having thermal conductivity. However, the present disclosure is not limited thereto, and any material capable of fixing the outer surface of the sealing part 110s may be included in the present embodiment.

Thereby, the fixing member (not shown) can prevent the sealing part 110s from being folded or damaged in the process of mounting the battery cell 110 in the housings 300 or 400.

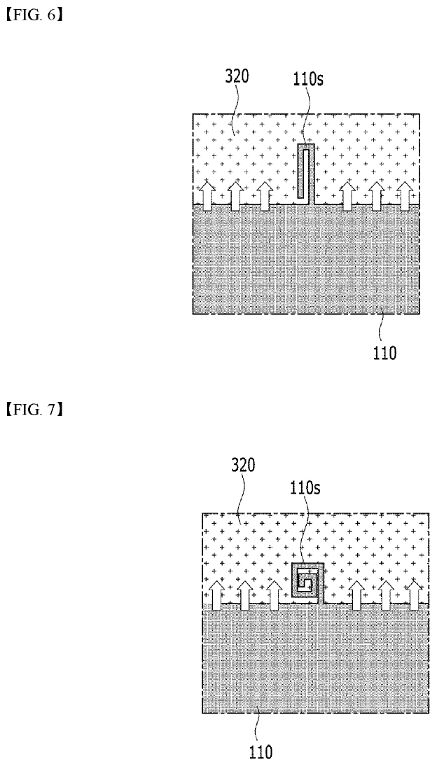

FIGS. 5 to 7 illustrate a sealing part according to another embodiment of the present disclosure.

Referring to FIGS. 1, 2, and 5 to 7, in the battery module 100 according to the present embodiment, the length of the sealing part 110s in a direction extending toward the upper part of the housings 300 and 400 is equal to or greater than the length of the sealing part 100s in a direction extending along the upper part of the battery cell 110, and the sealing part 110s may have various shapes other than the sealing parts 110s of FIGS. 3 and 4.

In one example, as shown in FIG. 5, the sealing part 110s may have a shape extending from the upper part of the battery cell 110 toward the upper part of the housings 300 and 400. In this case, the area occupied by the sealing part 110s on the battery cell 110 can be minimized. In addition, the entire outer surface of the sealing part 110s can be wrapped with the upper thermal conductive material layer 320.

Thereby, the contact area between the upper surface of the battery cell 110 and the upper to thermal conductive material layer 320 is maximized, so that the heat transfer area between the battery cell 110 and the upper thermal conductive material layer 320 can be maximized, and the cooling performance of the battery cell 110 due to the upper thermal conductive material layer 320 can be further improved.

In another example, as shown in FIG. 6, the sealing part 110s may have a shape that is folded once in a counterclockwise direction. In this case, by increasing the area of the sealing part 110s compared to FIG. 5, it is possible to improve the sealing property of the battery cell 110 and maximize space utilization in the battery module 100.

Thereby, the area occupied by the sealing part 110s on the upper part of the battery cell 110 can be minimized even when the sealing part 110s is folded at least once.

In another example, as shown in FIG. 7, the sealing part 110s may have a shape that is folded multiple times. More specifically, the length of the sealing part 110s in a direction extending toward the upper parts of the housings 300 and 400 is equal to or similar to the length of the sealing parts 110s in a direction extending along the upper portions of the battery cells 110. In this case, the length by which the sealing part 110s extends toward the upper part of the housings 300 and 400 is smaller than that of FIGS. 4 to 6, so that an area of the upper thermal conductive material layer 320 located on the upper part of the sealing part 110s can be maximized.

Thereby, in the battery cell 100 of the present embodiment, the degree of heat transfer between the upper part of the sealing part 110s and the upper thermal conductive material layer 320 can be increased and the cooling performance of the upper thermal conductive material layer 320 for the battery cell 110 can be improved.

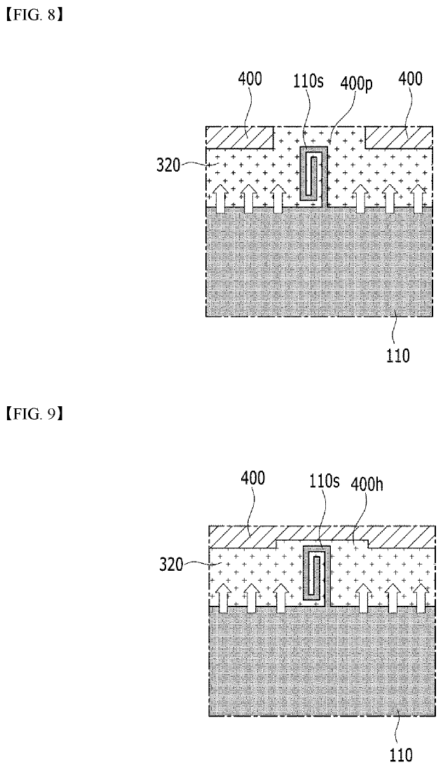

FIGS. 8 and 9 are illustrations of the upper part of the housing according to another embodiment of the present disclosure.

Referring to FIG. 8, in the battery module 100 according to another embodiment of the present disclosure, the housings 300 and 400 may include a penetrating part 400p through which a portion of the upper parts of the housings 300 and 400 penetrates. Here, the penetrating part 400p may be located on the upper part of the sealing part 110s. More specifically, the penetrating part 400p may be longer than the length of the sealing part 110s in a direction extending along the upper part of the battery cell 110.

In one example, the penetrating part 400p may be formed in a slit shape. However, the present disclosure is not limited thereto, and a penetrating portion from the upper part of the housings 300 and 400 may have various shapes.

Moreover, the upper thermal conductive material layer 320 may extend from the upper part of the housings 300 and 400 to the penetrating part 400p. In this case, the area of the upper thermal conductive material layer 320 located on the upper part of the sealing part 110s may be relatively increased.

Thereby, in the battery cell 100 of the present embodiment, the housings 300 and 400 includes a penetrating part 400p, so that the degree of heat transfer between the upper part of the sealing part 110s and the upper thermal conductive material layer 320 can be increased, and the cooling performance of the upper thermal conductive material layer 320 for the battery cell 110 can be effectively improved.

Referring to FIG. 9, in the battery module 100 according to another embodiment of the present disclosure, a recessed part 400h may be formed on the lower surface of the upper part of the housings 300 and 400. Here, the recessed part 400h may mean a portion that is recessed toward the upper surface of the upper part of the housings 300 or 400 from the lower surface of the upper part of the housing 300 or 400. In addition, the recessed part 400h may be located in the upper part of the sealing part 110s. More specifically, the recessed part 400h may be longer than the length of the sealing part 110s in a direction extending along the upper part of the battery cell 110.

Further, the upper thermal conductive material layer 320 may extend up to the inside of the recessed part 400h. In this case, the area of the upper thermal conductive material layer 320 located on the upper part of the sealing part 110s can be relatively increased.

Thereby, in the battery cell 100 of the present embodiment, the degree of heat transfer between the upper part of the sealing part 110s and the upper thermal conductive material layer 320 can be increased, and the cooling performance of the upper thermal conductive material layer 320 for the battery cell 110 can be improved. In addition, the upper part of the sealing to part 110s can be covered with the upper part of the housings 300 and 400, so that the battery cell 110 can be protected from external impact.

Next, a battery module according to a comparative example will be described, and the battery module according to the comparative example may be mostly described in the same manner as the battery module 100 described with reference to FIGS. 1 to 4, and the different parts will be mainly described

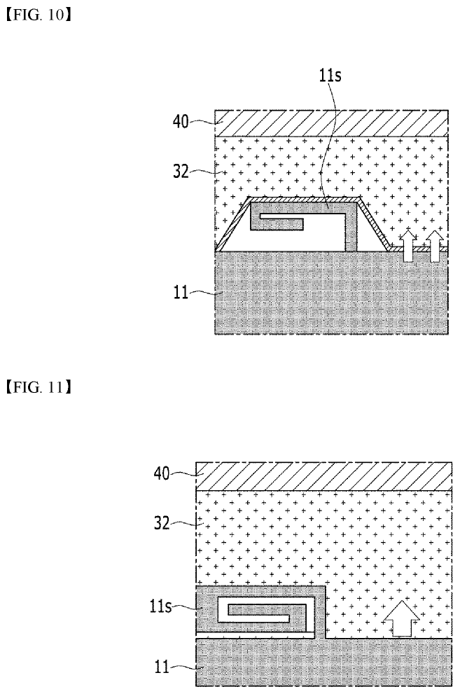

FIGS. 10 and 11 are illustrations of a sealing part according to a comparative example.

Referring to FIGS. 10 and 11, in the battery cell 11 included in the battery module according to the comparative example, the sealing part 11s is folded toward the upper part of the battery cell 11. More specifically, in the comparative example, the length of the sealing part 11s in a direction extending toward the upper plate 40 is smaller than the length of the sealing parts 1 is in a direction extending along the upper part of the battery cell 11. In this case, the area occupied by the sealing part 1 is on the upper part of the battery cell 11 is too large, so that the sealing part 11 s can hinder heat transfer between the upper thermal conductive material layer 32 and the upper part of the battery cell 11. In particular, the sealing part 1 is can act as a high thermal resistance in a heat transfer path between the upper thermal conductive material layer 32 and the upper part of the battery cell 11. Thereby, in the battery module of the comparative example, the sealing part 11s has a problem of degrading the cooling performance of the upper thermal conductive material layer 32 for the battery cell 11.

On the other hand, referring to FIGS. 1 to 9, in the battery module 100 according to the present embodiment, the length of the sealing part 110s in a direction extending toward the upper part of the housings 300 and 400 that is equal to or smaller than the length of the sealing parts 100s in a direction extending along the upper part of the battery cell 110, so that the area occupied by the sealing part 110s on the upper part of the battery cell 110 can be minimized, and the cooling performance of the upper thermal conductive material layer 320 for the battery cell 110 can also be further improved.

Meanwhile, one or more battery modules according to the present embodiment can be packaged in a pack case to form a battery pack.

The above-mentioned battery module and the battery pack including the same can be applied to various devices. Such a device can be applied to a vehicle means such as an electric bicycle, an electric vehicle, or a hybrid vehicle, but the present disclosure is not limited thereto, and is applicable to various devices that can use a battery module or a battery pack including the same, which is also falls under the scope of the present disclosure.

Although preferred embodiments of the present disclosure have been described in detail above, the scope of the present disclosure is not limited thereto, and various modifications and improvements can be made by those skilled in the art using the basic concepts of the present disclosure, which are defined in the appended claims, which also falls within the scope of the present disclosure.

1. A battery module comprising:
a battery cell stack comprising a plurality of battery cells;
a housing accommodating the battery cell stack; and
an upper thermal conductive material layer located between an upper surface of the battery cell stack and an upper part of the housing,
wherein each of the plurality of battery cells includes a sealing part
wherein the sealing part is arranged to extend from the each of the plurality of battery cells toward the upper part of the housing and the sealing part seals a part of an outer peripheral surface of each of the plurality of battery cells,
wherein the upper thermal conductive material layer surrounds an outer surface of the sealing part, and
wherein a length of the sealing part in a direction extending toward the upper part of the housing is equal to or greater than a length of the sealing part in a direction extending along the upper surface of the each of the plurality of battery cells.

2. The battery module according to claim 1, wherein:
the length of the sealing part in the direction extending toward the upper part of the housing is greater than the length of the sealing part in the direction extending along the upper surface of the plurality of battery cells.

3. The battery module according to claim 1, wherein:
the sealing part is folded at least once in a clockwise or counterclockwise direction to form a folded surface.

4. The battery module according to claim 3, wherein:
an internal thermal conductive material layer is located on the folded surface.

5. The battery module according to claim 3, wherein:
the sealing part is folded a plurality of times to form a plurality of folded surfaces, and
the plurality of folded surfaces are in contact with each other.

6. The battery module according to claim 1, wherein:
the housing includes a penetrating part,
the penetrating part is formed in a section of the upper part of the housing, and
the penetrating part is located to correspond to an upper surface of the sealing part.

7. The battery module according to claim 6, wherein:
the upper thermal conductive material layer extends into the penetrating part.

8. The battery module according to claim 7, wherein:
a length of the penetrating part is greater than the length of the sealing part extending in a direction along the upper part of the each of the plurality of battery cells.

9. The battery module according to claim 1, wherein:
a recessed part is formed on a lower surface of the upper part of the housing,
the recessed part is recessed toward an upper surface of the upper part of the housing from a lower surface of the upper part of the housing, and
the recessed part is located to correspond to an upper surface of the sealing part.

10. The battery module according to claim 9, wherein:
the upper thermal conductive material layer extends into the penetrating part through an inside of the recessed part.

11. The battery module according to claim 10, wherein:
a size of the recessed part is larger than the length of the sealing part extending in a direction along the upper surface of the each of the plurality of battery cells.

12. The battery module according to claim 1, further comprising:
a lower thermal conductive material layer between the lower surface of the battery cell stack and a lower part of the housing.

13. A battery pack comprising the battery module as set forth in claim 1.
